(19) United States
(12) Patent Application Publication
(10) Pub. No.: US 2023/0165398 A1
(43) Pub. Date: Jun. 1, 2023

(54) COFFEE TAMPING TOOL AND METHODS OF USING SAME

(71) Applicant: Daniel Kurnianto, Westford, MA (US)

(72) Inventor: Daniel Kurnianto, Westford, MA (US)

(21) Appl. No.: 18/070,841

(22) Filed: Nov. 29, 2022

Related U.S. Application Data
(60) Provisional application No. 63/283,574, filed on Nov. 29, 2021.

(51) Int. Cl. A47J 31/06; A47J 31/44; A47J 31/52

(52) U.S. Cl. CPC A47J 31/0663; A47J 31/4464; A47J 31/52

(57) ABSTRACT

A coffee tamping tool, comprising: a main body including, an internal compartment; and, a portafilter receptacle area configured for receipt of a portafilter therein; a control circuit board disposed within the internal compartment; and, a tamper disc disposed within the portafilter receptacle area.

### RELATED APPLICATION

This application claims the benefit of priority under 35 U.S.C. § 119(e) of U.S. Provisional Patent Application No. 63/283,574 filed Nov. 29, 2021, the contents of which are incorporated herein by reference in their entirety.

### FIELD OF THE INVENTION

The present invention, in some embodiments thereof, relates to the retail beverage industry and, more particularly, but not exclusively, to a tool for making a coffee beverage.

### BACKGROUND OF THE INVENTION

One of the process steps for making espresso is tamping the coffee grounds inside the portafilter basket of the brewing machine. To achieve consistency in the taste of the espresso, even tamping is required which packs the coffee grounds to a consistent density and/or compactness. To achieve this consistency requires skill, knowledge and experience when tamping manually by hand, which is the most common tamping process. Some users utilize a desktop electronic tamper which requires high voltage to run (needs to be plugged into the wall), generally stays in one place, takes up a lot of space because of its size, and/or is expensive.

### SUMMARY OF THE INVENTION

According to an aspect of some embodiments of the present invention there is provided a coffee tamping tool, comprising: a main body including, an internal compartment; and, a portafilter receptacle area configured for receipt of a portafilter therein; a control circuit board disposed within the internal compartment; and, a tamper disc disposed within the portafilter receptacle area.

In an embodiment of the invention, the portafilter receptacle area is formed by at least one portafilter locking flap reversibly interlockable with a portafilter.

In an embodiment of the invention, wherein the at least one locking flap is L-shaped and configured inwardly facing the tamper disc within the portafilter receptacle area.

In an embodiment of the invention, the tool further comprises at least one sensor, in operative communication with the control circuit board, disposed in the portafilter receptacle area for sensing the presence of a portafilter in the portafilter receptacle area.

In an embodiment of the invention, the at least one sensor is a light sensing sensor.

In an embodiment of the invention, the at least one sensor is pressure activated. In an embodiment of the invention, the control circuit board is configured to automatically activate the tamper disc upon the sensing of the presence of the portafilter by the at least one sensor.

In an embodiment of the invention, the tool is configured with a connection to a controller device to control operation and/or monitor operational status of the coffee tamping tool.

In an embodiment of the invention, the tool is configured with a plurality of operational modes.

In an embodiment of the invention, the plurality of operational modes comprises varying pressure, distance of travel of the tamping disc, duration of applied pressure and/or pre-set performance profiles.

In an embodiment of the invention, the tool further comprises at least one control switch for controlling aspects of operation of the coffee tamping tool.

In an embodiment of the invention, the tool further comprises a display for providing information related to the coffee tamping tool.

In an embodiment of the invention, the tamping disc is centrally located in the receptacle area.

In an embodiment of the invention, the portafilter receptacle area is configured to accommodate a range of portafilter sizes.

In an embodiment of the invention, the portafilter receptacle area is 75 mm in diameter.

In an embodiment of the invention, there is at least one opening provided to the receptacle area for insertion of a protrusion of the portafilter therethrough.

In an embodiment of the invention, the tool further comprises operational components including an actuator, a rotator frame, and a shaft operatively connected to the tamper disc.

In an embodiment of the invention, the tool further comprises at least one twisting slot disposed in the rotator frame with a counterpart pin located on the shaft, wherein the pin is inserted through the at least one twisting slot, such that activation of the coffee tamping tool causes the counterpart pin to transit within the at least one twisting slot to extend or retract the shaft.

In an embodiment of the invention, the actuator is operatively connected to the shaft by a plurality of gears.

In an embodiment of the invention, the tamper disc is interchangeable with a number of differently configured tamper discs.

In an embodiment of the invention, the tool further comprises a battery.

In an embodiment of the invention, the battery is rechargeable.

According to a further aspect of some embodiments of the present invention there is provided a method of using a coffee tamping tool, comprising: charging the coffee tamping tool prior to use for tamping operation; placing the coffee tamping tool on a portafilter by inserting at least one protrusion of the portafilter through at least one opening of at least one locking flap; locking the coffee tamping tool on the portafilter by twisting the portafilter relative to the coffee tamping tool; activating the coffee tamping tool to compress coffee within the portafilter; and, unlocking the coffee tamping tool from the portafilter by twisting the portafilter in direction opposite the twisting to perform the locking.

In an embodiment of the invention, activating occurs automatically when at least one sensor of the coffee tamping tool senses the presence of the portafilter.

In an embodiment of the invention, activating occurs manually.

In an embodiment of the invention, the method further comprises grinding coffee into the portafilter before placing the coffee tamping tool on the portafilter.

In an embodiment of the invention, the method further comprises distributing coffee grounds evenly in the portafilter before activating the coffee tamping tool.

In an embodiment of the invention, the method further comprises selecting one of a plurality of operational modes of the coffee tamping tool prior to the activating.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIG. 1 is a top perspective view of a coffee tamping tool, in accordance with an exemplary embodiment of the invention;

FIG. 2 is a bottom perspective view of a coffee tamping tool, in accordance with an exemplary embodiment of the invention;

FIGS. 3A-3D are top, bottom, side and front/back views, respectively, of a coffee tamping tool, in accordance with an exemplary embodiment of the invention;

FIG. 4 is a left side internal view of a coffee tamping tool, in accordance with an exemplary embodiment of the invention;

FIG. 5 is a right side internal view of a coffee tamping tool, in accordance with an exemplary embodiment of the invention;

FIG. 6 is a front internal view of a coffee tamping tool, in accordance with an exemplary embodiment of the invention;

FIG. 7 is a back internal view of a coffee tamping tool, in accordance with an exemplary embodiment of the invention;

FIG. 8 is schematic view of the top of a coffee tamping tool, in accordance with an exemplary embodiment of the invention;

FIG. 9 is a view of a coffee tamping tool in a tamping configuration, in accordance with an exemplary embodiment of the invention;

FIG. 10 is a top perspective, partially exploded view of a coffee tamping tool, in accordance with an exemplary embodiment of the invention;

FIG. 11 is a bottom perspective, partially exploded view of a coffee tamping tool, in accordance with an exemplary embodiment of the invention;

FIG. 12A is a cross-sectional view of a coffee tamping tool, in accordance with an exemplary embodiment of the invention, and a portafilter;

FIG. 12B is a cross-sectional view of a coffee tamping tool, in accordance with an exemplary embodiment of the invention, attached to a portafilter;

FIGS. 13A-13E are sequential, perspective views showing a method of using a coffee tamping tool, in accordance with an exemplary embodiment of the invention; and,

FIG. 14 is a flowchart of a method of using a coffee tamping tool, in accordance with an exemplary embodiment of the invention.

### DESCRIPTION OF SPECIFIC EMBODIMENTS OF THE INVENTION

The present invention, in some embodiments thereof, relates to the retail beverage industry and, more particularly, but not exclusively, to a tool for making a coffee beverage.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

Generally, the tool described herein aims to get the same consistency in compactness/density as the manual tamping tools and/or the expensive desktop electronic tampers, is easy to use, is handheld due to a small size, is largely automated, is powered, and/or is easy to carry and move around because of its lightweight characteristics.

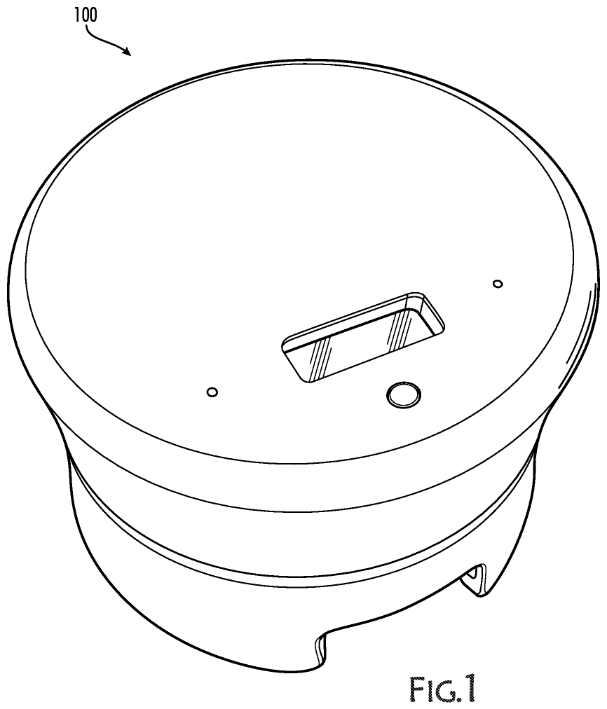

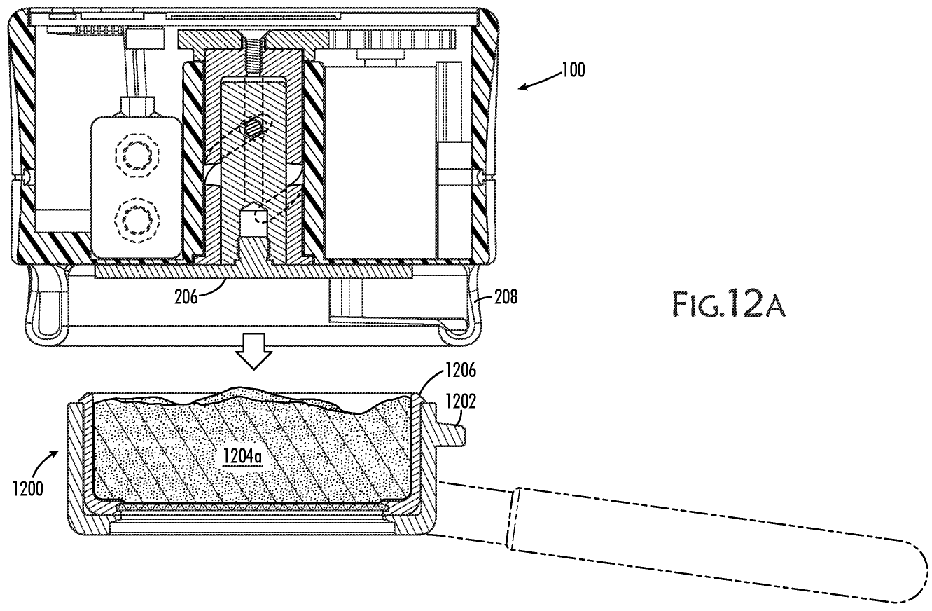

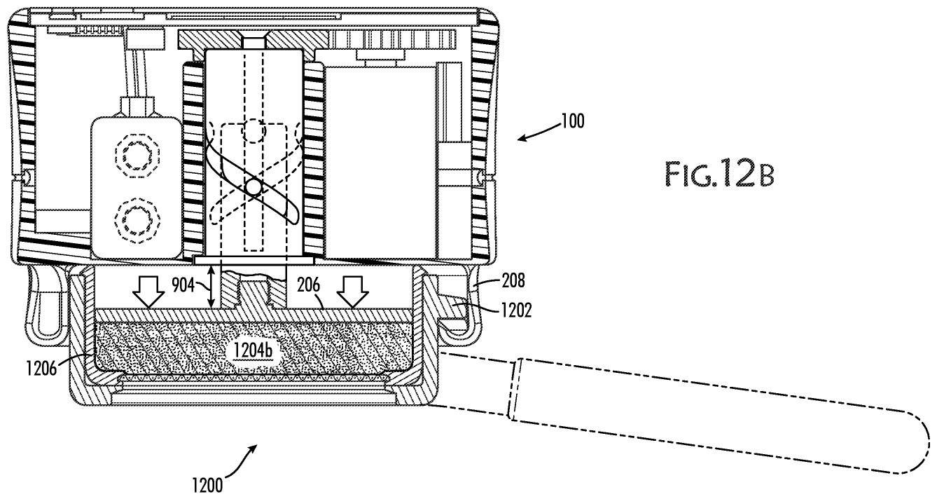

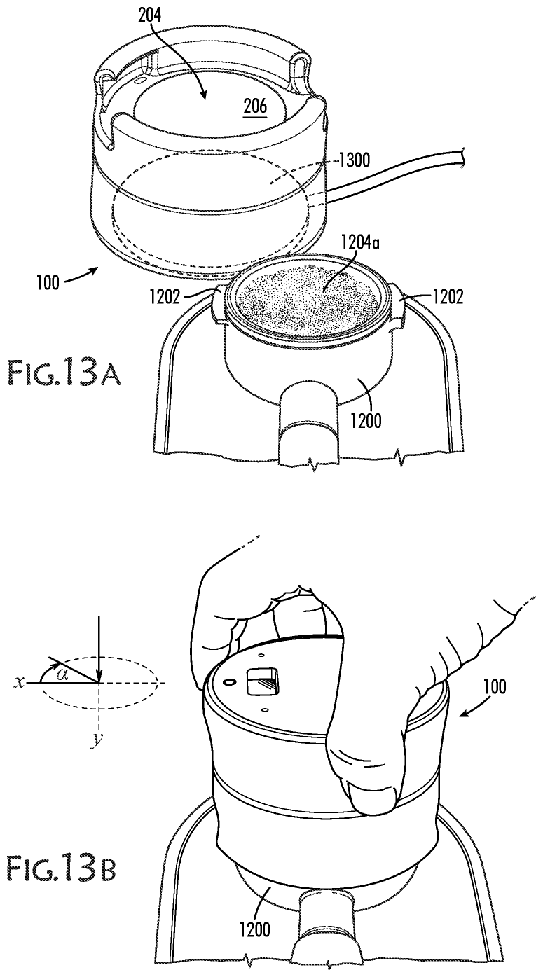

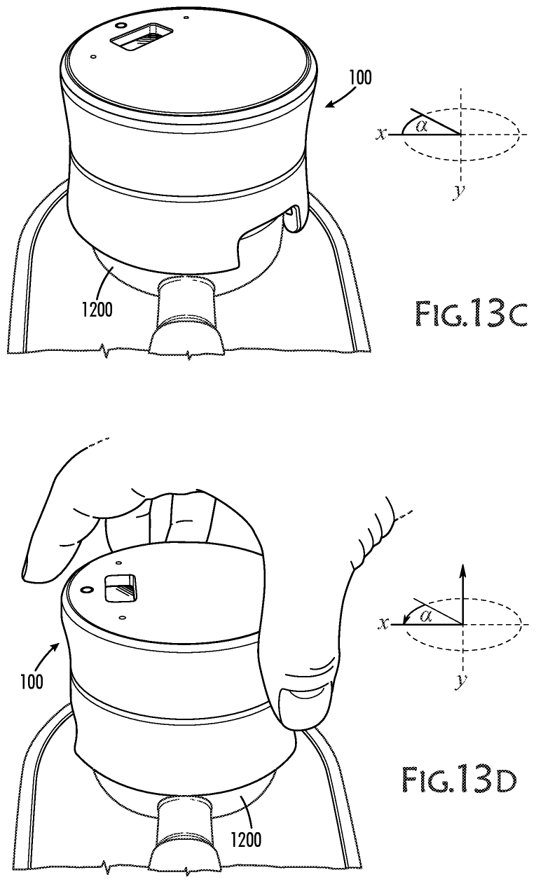

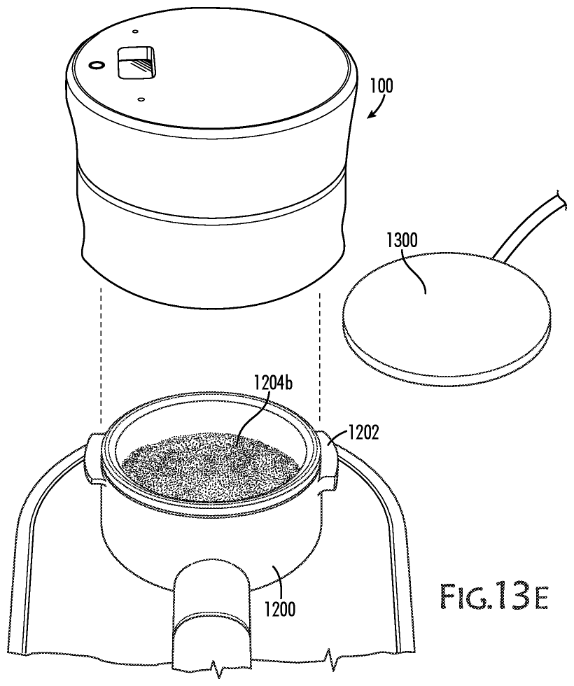

Referring now to the drawings, FIG. 1 is a top perspective view of a coffee tamping tool 100, in accordance with an exemplary embodiment of the invention. The tool 100, as will be described in more detail herein, is designed to consistently, automatically tamp ground coffee while being configured to be handheld (e.g. by size and by having ergonomically shaped/sloped/concave sides for grasping) and placed onto an industry standard portafilter (shown and described in more detail with respect to FIGS. 12A-B and FIGS. 13A-13E), while being wirelessly powered, in some embodiments of the invention.

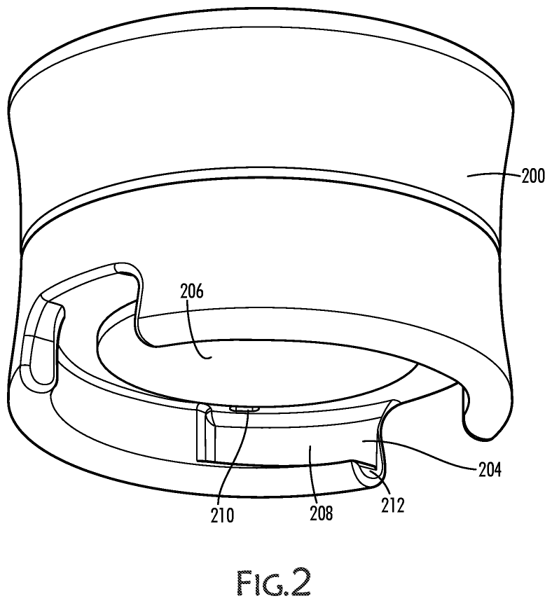

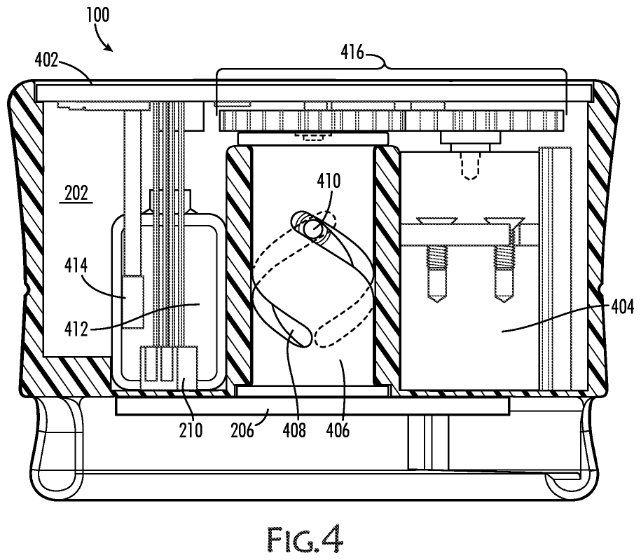

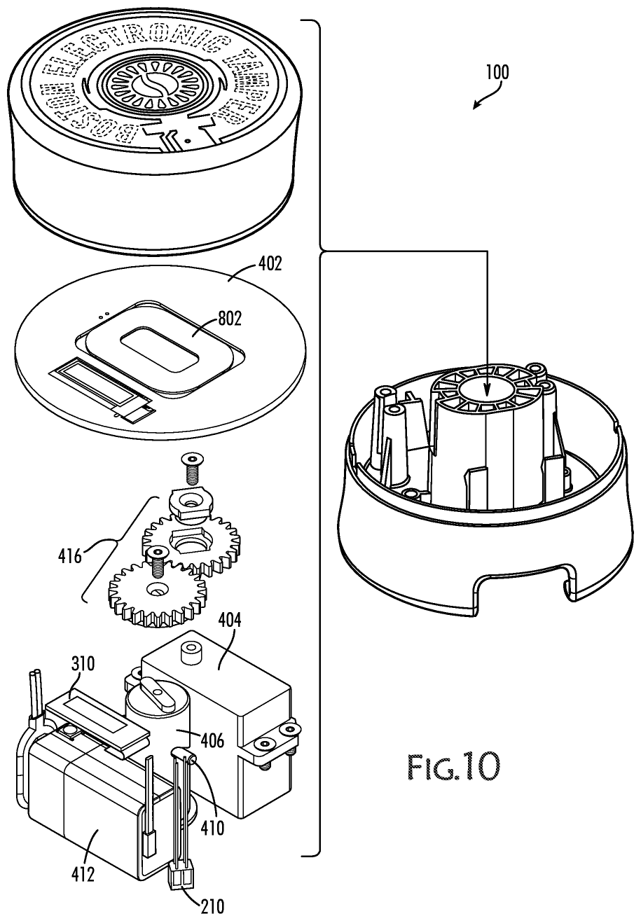

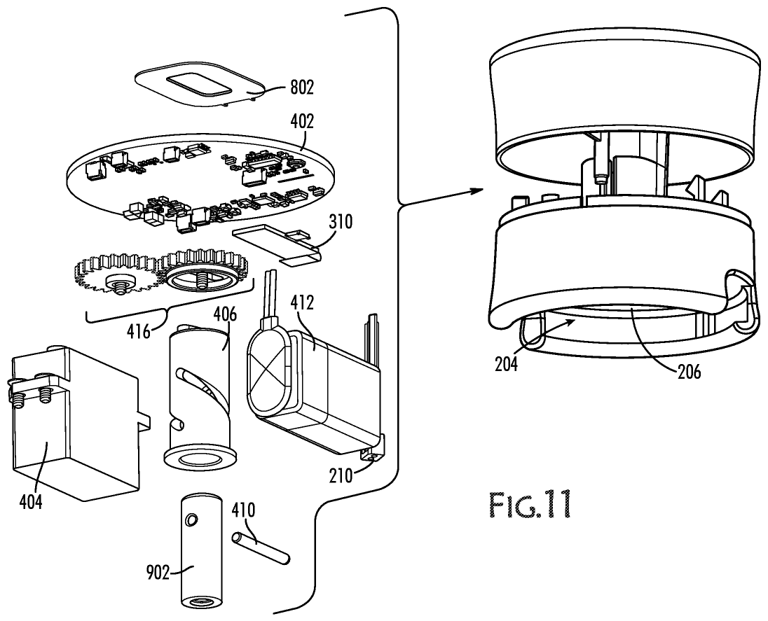

FIG. 2 is a bottom perspective view of the coffee tamping tool 100, in accordance with an exemplary embodiment of the invention. The coffee tamping tool 100 includes a main body 200 which is provided with an internal compartment 202 (as shown in FIG. 4) for various operative components (such as shown and described in more detail with respect to FIGS. 10 and 11) of the tool 100 as well as a portafilter receptacle area 204 where the tool 100 is attached to a portafilter to execute a coffee tamping operation. In an embodiment of the invention, a tamper disc 206 is disposed within the receptacle area 204, the tamper disc 206 usable by the tool 100 to apply pressure to coffee grounds located in the portafilter during the tamping operation. In some embodiments of the invention, the receptacle area 204 is formed by at least one portafilter locking flap 208 which are designed/configured to interlock with the portafilter to lock the portafilter to the tool 100 during use. In some embodiments of the invention, the tamper disc 206 is replaceable and/or is interchangeable with a number of differently configured tamper discs (for example, having different diameters or thicknesses).

As can be seen in FIG. 2, the at least one locking flap 208 is shaped as a counterpart to at least one protrusion on a standard portafilter whereby twisting/rotating the portafilter in the receptacle area serves to interlock the portafilter to the tool 100 by disposing the protrusion within the locking flap 208, and likewise, twisting rotating the portafilter in the opposite direction serves to unlock the portafilter from the tool 100 (as described in more detail below). The at least one locking flap, for example, could be shaped like an inwardly facing L, where the lower portion 212 of the L-shape mechanically holds the portafilter protrusion in the locking flap 208. In some embodiments of the invention, the receptacle area 204 is provided with a sensor 210 which senses if/when a portafilter has been interlocked with the tool 100. The sensing of the portafilter by the sensor 210 activates the coffee tamping operation of the tool 100 automatically, in some embodiments of the invention. In some embodiments of the invention, the sensor 210 is a light-sensing sensor, for example a photodiode. In some embodiments of the invention, the sensor 210 is a pressure-sensing sensor, for example when the portafilter is slid into the locking flap 208, the protrusion presses on the sensor 210 to indicate its presence within the receptacle area 204.

In some embodiments of the invention, the tool 100 is configured for a wired or wireless connection to a controller device, such as a smart phone or tablet, such that operation of the tool 100 can be controlled from the controller device. For example, the tool 100 can be activated or deactivated, different modes can be selected and/or battery charging status and/or charge status can be controlled or viewed from the controller device. Optionally, the tool's 100 firmware can be updated from the controller device.

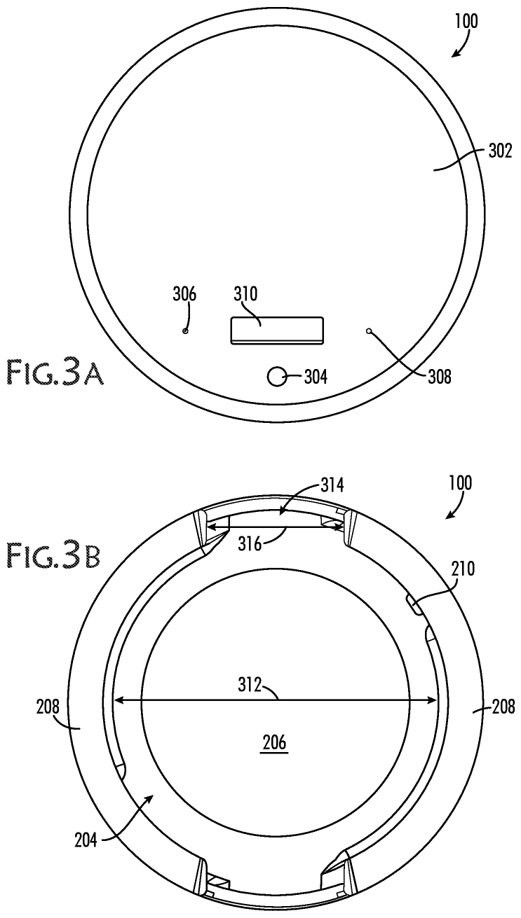

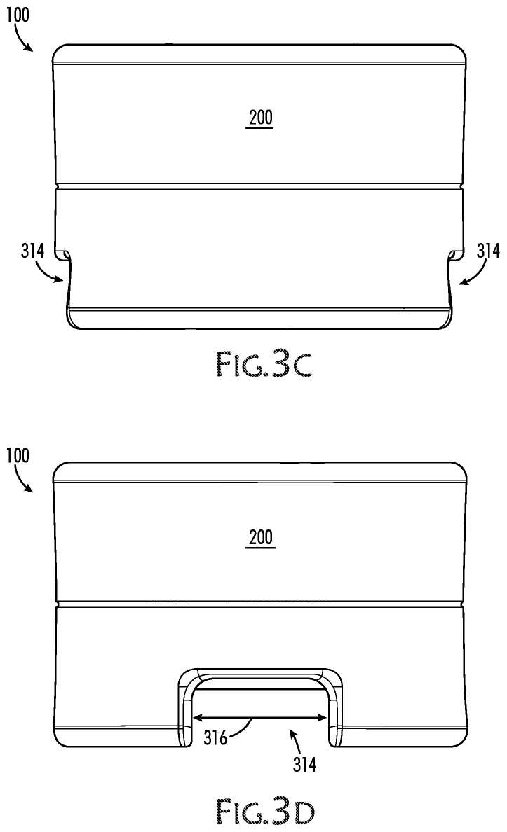

FIGS. 3A-3D are top, bottom, side and front/back views, respectively, of the coffee tamping tool 100, in accordance with an exemplary embodiment of the invention. The top view of FIG. 3A shows various features for the tool 100, including a cover 302, a power switch/button 304 and two control switches/buttons 306, 308 for operating the tool 100. It should be understood that while the power switch 304 and two control switches 306, 308 are shown on the top of the tool 100, they could be located just about anywhere on the body 200 of the tool 100 and there could be no, one or more than two control switches. That is, the number and/or location of the power switch 304 and/or the two control switches 306, 308 shown in FIG. 3A are by way of example only. In some embodiments of the invention, at least one of the control switches 306, 308 is used to select one of multiple operational modes of the tool 100. Different operational modes can vary the amount of pressure applied to the coffee (in combination with at least one pressure/force sensor), the distance of travel of the tamper, the duration of applied pressure (even at different levels of distance of travel), and/or reflect pre-set performance profiles to apply differing tamping to the coffee in the portafilter depending on the wishes of the user/barista and/or the customer. In some embodiments of the invention, at least one of the switches 306, 308 uses capacitive sensing. In some embodiments of the invention, at least one of the switches 306, 308 is mechanical.

In some embodiments of the invention, the top of the tool 100 includes a display 310 for providing information to the user. For example, the display 310 can show which operational mode the tool 100 is in and/or how much distance the tamper is traveling or will travel and/or how much pressure is being applied to the coffee in the portafilter and/or the battery status of the tool 100 and/or charging status of the tool 100.

FIG. 3B shows a bottom view of the coffee tamping tool 100, in accordance with an exemplary embodiment of the invention. The tamper disc 206 is centrally located on the bottom, in some embodiments of the invention. As portafilters and baskets (for placement within the portafilter) vary in size, but generally come in a range of industry standard sizes (diameters), the receptacle area 204 is configured to accommodate a range of these standard sizes, in an exemplary embodiment of the invention. For example, the diameter 312 of the receptacle area 204 is 75 mm, in some embodiments of the invention. This diameter 312 could be larger or smaller, for example, to be directed towards a specific portafilter or basket size. In some embodiments of the invention, the receptacle area 204 is configured to receive basket sizes of 58 mm diameter, 57 mm diameter, 54 mm diameter, 53 mm diameter, 51 mm diameter, and/or 49 mm diameter. Optionally, the receptacle area 204 is configured to receive larger or smaller basket sizes.

Additionally, alternatively and/or optionally, there is at least one opening 314 provided wherein a protrusion of the portafilter is inserted in order to interlock the portafilter to the tool 100. Optionally, there are two openings 314. Optionally, there are three openings 314. It should be understood that not all portafilters have the same number of protrusions and that the tool 100 should have at least as many openings 314 as the portafilter with which the tool 100 is intended to be used. The length 316 of the opening 314 could vary from one embodiment of the tool 100 to another embodiment, depending on the portafilter model the tool 100 is intended to be used with, as some portafilters have different sized protrusions.

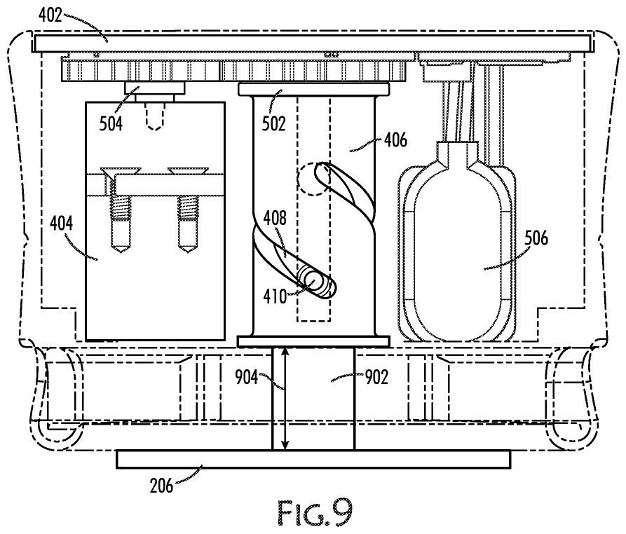

FIG. 4 is a left side internal view of the coffee tamping tool 100, in accordance with an exemplary embodiment of the invention. This view shows internal components of the tool 100 located within an internal compartment 202, in accordance with an exemplary embodiment of the invention. In an embodiment of the invention, a control circuit board 402 is provided to house electronics used for controlling operational components of the tool 100, including an actuator 404, a rotator frame 406 which includes at least one twisting slot 408, or a pair of mirror image twisting slots on opposing sides of the frame 406, wherein the slot(s) 408 corresponds to a counterpart pin 410 located on a shaft 902 (shown in more detail with respect to FIG. 9) operatively connected to the tamper disc 206 to effectuate extension of the shaft 902 (and thus the tamper disc 206) when the tool 100 is activated. In some embodiments of the invention, the pin 410 extends through the sides of the rotator frame 406.

In an embodiment of the invention, the tool 100 is provided with a battery 412, for example a rechargeable battery in some embodiments of the invention, for providing power to the actuator 404 and/or the display 310 and/or other components of the tool 100 requiring a power source. In some embodiments of the invention, the battery 412 is recharged through a battery charging connector 414. FIG. 4 also shows a sensor 210 structure, in accordance with an exemplary embodiment of the invention.

In some embodiments of the invention, the actuator 404 is operatively connected to the shaft 902 by a series of gears 416 of the tool's movement mechanism which effectuate movement of the pin 410 through the slot 408 to advance the shaft 902 downwardly and upwardly as the pin 410 moves through the slot 408. The gear 416 arrangement is shown and described in more detail with respect to FIGS. 10 and 11.

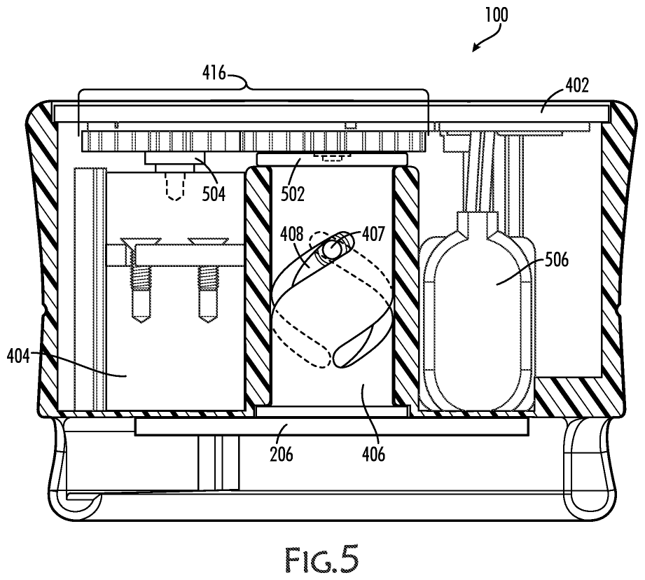

FIG. 5 is a right side internal view of the coffee tamping tool 100, in accordance with an exemplary embodiment of the invention. From this side of the tool 100, additional details of the movement mechanism are shown, for example an actuator gear 502 attached to the rotator frame 406 side of the movement mechanism and a driver gear 504 attached to the actuator 404 side of the movement mechanism.

In some embodiments of the invention, the tool 100 is provided with a battery clip 506 to hold the battery 412 within the internal compartment 202.

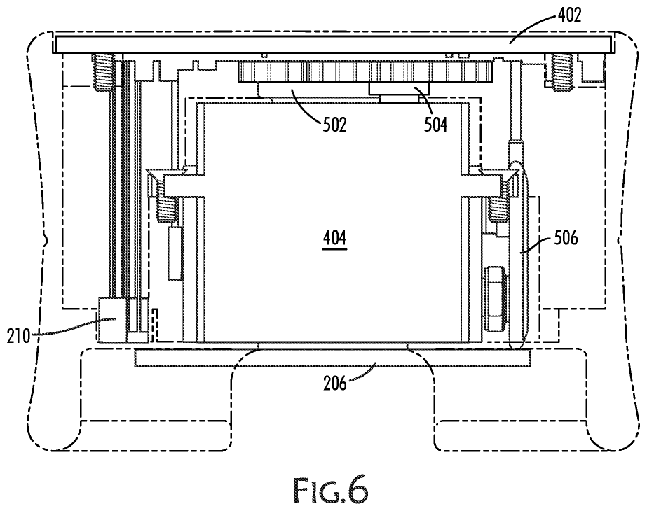

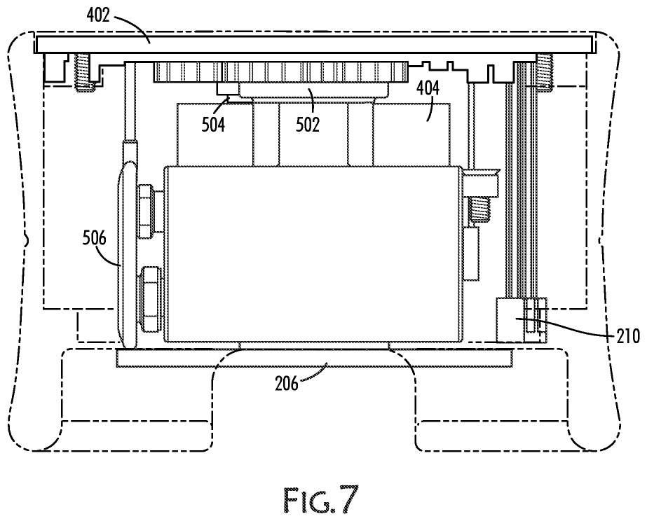

FIG. 6 is a front internal view and FIG. 7 is a back internal view of the coffee tamping tool 100, in accordance with an exemplary embodiment of the invention. FIG. 7 is representative of the “stand by” operational configuration of the tool 100, wherein a portafilter has not been interlocked with the tool 100 and the tamper disc 206 is retracted.

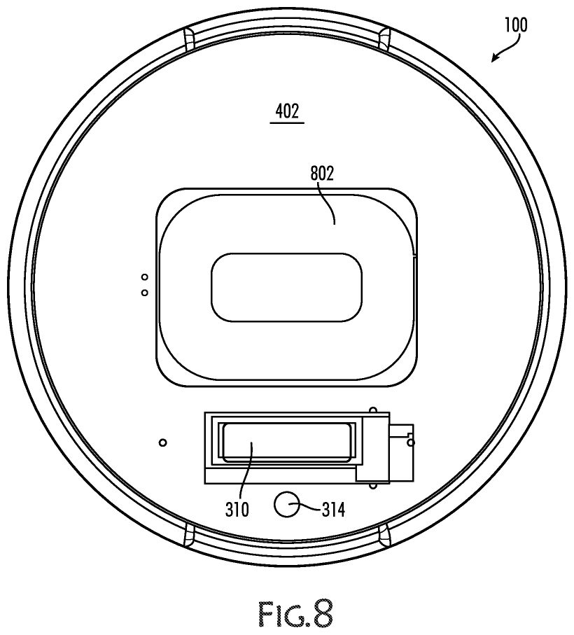

FIG. 8 is schematic view of the top of the coffee tamping tool 100, in accordance with an exemplary embodiment of the invention. In some embodiments of the invention, the tool 100 is rechargeable. For example, the battery 412 is a rechargeable battery. The rechargeable battery is charged, in some embodiments of the invention, by a wireless charging receiver 802. In some embodiments of the invention, the wireless charging receiver 802 includes an inductive coil. Optionally, the charging receiver 802 is Qi standard compliant, for example, the tool 100 is wirelessly chargeable via the wireless charging receiver 802 by placing it on a Qi-compliant charging pad. It should be understood that the wireless charging receiver 802 could be just about anywhere on the body 200 of the tool 100 and is shown on the top in this embodiment only as an example.

FIG. 9 is a view of the coffee tamping tool 100 in a tamping configuration, in accordance with an exemplary embodiment of the invention. The tamper disc 206 is extended in a downward direction where the coffee in the portafilter would be located if the portafilter was shown in this Figure. In some embodiments of the invention, the travel distance 904 of the shaft 902 is up to 20 mm Optionally, the travel distance 904 is longer or shorter, depending on the length of the shaft 902 and/or the operational mode of the tool 100. In some embodiments of the invention, the force applied to the coffee in the portafilter is up to 30 lbs. Optionally, the applied force is greater than 30 lbs.

FIG. 10 is a top perspective, partially exploded view of the coffee tamping tool 100, in accordance with an exemplary embodiment of the invention. The gears 416 are more easily viewed in FIG. 10. While a gear mechanism is shown in this example, it should be understood that any movement mechanism that effectuates downward/upward movement of the shaft 902 could potentially be used, for example a worm gear. FIG. 11 is a bottom perspective, partially exploded view of the coffee tamping tool 100, in accordance with an exemplary embodiment of the invention.

FIG. 12A is a cross-sectional view of the coffee tamping tool 100, in accordance with an exemplary embodiment of the invention, and a portafilter 1200. The portafilter 1200 is shown with a protrusion 1202 which interlocks with the portafilter locking flap 208 during operation of the tool 100, such as shown in FIG. 12B. It should be understood that while only a single protrusion 1202 is shown, there are often two or three protrusions on a standard portafilter (for example, as shown in FIG. 13A). In use, loose coffee grounds 1204a are positioned within a basket 1206 in the portafilter 1200 prior to tool 100 activation, and after tool 100 activation where the tamper disc 206 is lowered towards the portafilter 1200, such as shown in FIG. 12B, the coffee grounds become compacted coffee grounds 1204b as a result of the exerted pressure/force from the tamper disc 206.

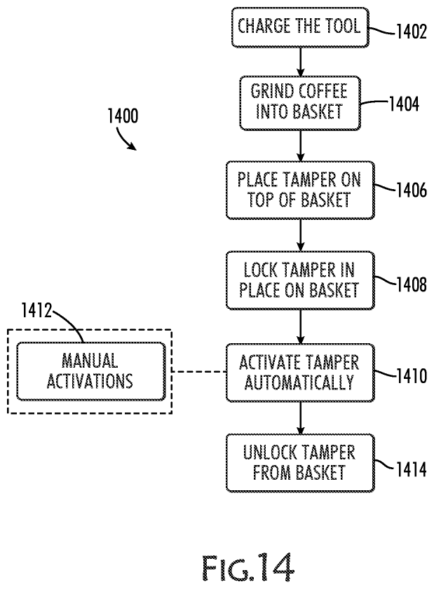

FIGS. 13A-13E are sequential, perspective views graphically showing a method of using the coffee tamping tool 100, in accordance with an exemplary embodiment of the invention. In the interests of brevity, the views of FIGS. 13A-13E are described in conjunction with the flowchart 1400 shown in FIG. 14 of the method of using the coffee tamping tool 100, in accordance with an exemplary embodiment of the invention. In an embodiment of the invention, the tool 100 is charged (1402) prior to use for tamping operation, such as shown in FIG. 13A where the tool 100 is placed with the top down adjacent to a wireless charging pad 1300. Portafilter 1200 contains loose coffee which has been ground (1404) into the basket.

FIG. 13B shows the tool 100 being placed (1406) onto the portafilter 1202, wherein the openings 314 are placed over the portafilter protrusions 1202. The coffee tamping tool 100 is locked (1408) onto the portafilter by rotating/twisting the tamping tool 100 relative to the portafilter 1202 such that the protrusions slide into the locking flaps 208. In an embodiment of the invention, the tool 100 activates (1410) tamping operation automatically when the at least one sensor 210 detects that the portafilter 1202 has been locked to the tool 100. Optionally, the tool 100 is activated manually (1412) with a button or control switch. In an embodiment of the invention, the tamper disc 206 is pressed into the coffee grounds 1204a in accordance with an operational mode (if such is selected) and then is retracted once the intended force, pressure, time, etc. is achieved. The tool 100 is then unlocked (1414) from the portafilter 1202 and removed, leaving compacted coffee grounds 1202b in the portafilter basket.

In some embodiments of the invention, a distribution tool is provided to the coffee tamping tool 100 to evenly distribute the coffee grounds 1204a in the basket, for example before the tool 100 is activated for tamping. Optionally, the distribution tool is a blade which turns around in the basket of the portafilter as the shaft 902 turns during advancement. In some embodiments of the invention, the distribution tool is integrated with the tamper disc 206.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A coffee tamping tool, comprising:
a main body including,
an internal compartment; and,
a portafilter receptacle area configured for receipt of a portafilter therein;
a control circuit board disposed within the internal compartment; and,
a tamper disc disposed within the portafilter receptacle area.

2. The coffee tamping tool according to claim 1, wherein the portafilter receptacle area is formed by at least one portafilter locking flap reversibly interlockable with a portafilter.

3. The coffee tamping tool according to claim 2, wherein the at least one locking flap is L-shaped and configured inwardly facing the tamper disc within the portafilter receptacle area.

4. The coffee tamping tool according to claim 1, further comprising at least one sensor, in operative communication with the control circuit board, disposed in the portafilter receptacle area for sensing the presence of a portafilter in the portafilter receptacle area.

5. The coffee tamping tool according to claim 4, wherein the at least one sensor is a light sensing sensor.

6. The coffee tamping tool according to claim 4, wherein the at least one sensor is pressure activated.

7. The coffee tamping tool according to claim 4, wherein the control circuit board is configured to automatically activate the tamper disc upon the sensing of the presence of the portafilter by the at least one sensor.

8. The coffee tamping tool according to claim 1, configured with a connection to a controller device to control operation and/or monitor operational status of the coffee tamping tool.

9. The coffee tamping tool according to claim 1, configured with a plurality of operational modes.

10. The coffee tamping tool according to claim 9, wherein the plurality of operational modes comprises varying pressure, distance of travel of the tamping disc, duration of applied pressure and/or pre-set performance profiles.

11. The coffee tamping tool according to claim 1, further comprising at least one control switch for controlling aspects of operation of the coffee tamping tool.

12. The coffee tamping tool according to claim 1, further comprising a display for providing information related to the coffee tamping tool.

13. The coffee tamping tool according to claim 1, wherein the tamping disc is centrally located in the receptacle area.

14. The coffee tamping tool according to claim 1, wherein the portafilter receptacle area is configured to accommodate a range of portafilter sizes.

15. The coffee tamping tool according to claim 14, wherein the portafilter receptacle area is 75 mm in diameter.

16. The coffee tamping tool according to claim 1, wherein there is at least one opening provided to the receptacle area for insertion of a protrusion of the portafilter therethrough.

17. The coffee tamping tool according to claim 1, further comprising operational components including an actuator, a rotator frame, and a shaft operatively connected to the tamper disc.

18. The coffee tamping tool according to claim 17, further comprising at least one twisting slot disposed in the rotator frame with a counterpart pin located on the shaft, wherein the pin is inserted through the at least one twisting slot, such that activation of the coffee tamping tool causes the counterpart pin to transit within the at least one twisting slot to extend or retract the shaft.

19. The coffee tamping tool according to claim 18, wherein the actuator is operatively connected to the shaft by a plurality of gears.

20. The coffee tamping tool according to claim 1, wherein the tamper disc is interchangeable with a number of differently configured tamper discs.

21. The coffee tamping tool according to claim 1, further comprising a battery.

22. The coffee tamping tool according to claim 21, wherein the battery is rechargeable.

23. A method of using a coffee tamping tool, comprising:
charging the coffee tamping tool prior to use for tamping operation;
placing the coffee tamping tool on a portafilter by inserting at least one protrusion of the portafilter through at least one opening of at least one locking flap;
locking the coffee tamping tool on the portafilter by twisting the portafilter relative to the coffee tamping tool;
activating the coffee tamping tool to compress coffee within the portafilter; and,
unlocking the coffee tamping tool from the portafilter by twisting the portafilter in direction opposite the twisting to perform the locking.

24. The method according to claim 23, wherein activating occurs automatically when at least one sensor of the coffee tamping tool senses the presence of the portafilter.

25. The method according to claim 23, wherein activating occurs manually.

26. The method according to claim 23, further comprising grinding coffee into the portafilter before placing the coffee tamping tool on the portafilter.

27. The method according to claim 23, further comprising distributing coffee grounds evenly in the portafilter before activating the coffee tamping tool.

28. The method according to claim 23, further comprising selecting one of a plurality of operational modes of the coffee tamping tool prior to the activating.
